(19) United States
(12) Patent Application Publication
(10) Pub. No.: US 2009/0183867 A1
(43) Pub. Date: Jul. 23, 2009

(54) VARYING AMBIENT HEAT EXCHANGER FOR A COMPRESSOR

(75) Inventors: Kevin Bales, Oklahoma City, OK (US); James A. Holt, Oklahoma City, OK (US); Kyle Gordon, Oklahoma City, OK (US)

Correspondence Address: BUSKOP LAW GROUP, P.C., 4511 Dacoma Street, HOUSTON, TX, 77092, US

(73) Assignee: COMPRESSOR SYSTEMS INC., Midland, TX (US)

(21) Appl. No.: 12/018,367

(22) Filed: Jan. 23, 2008

(51) Int. Cl. G05D 23/00; F28F 9/02

(52) U.S. Cl. 165/299; 165/158

(57) ABSTRACT

A heat exchanger for a compressor comprising a housing comprising a plurality of pass chambers, wherein each pass chamber comprises a plurality of tubes for contacting a hot fluid with a cooling media. At least one first flow nozzle introduces a first portion of the hot fluid into a first pass chamber. At least one second flow nozzle downstream of the first flow nozzle introduces a second portion of the hot fluid into at least one downstream pass chamber, forming a reduced rate of fluid flow in the first pass chamber and optimizing contact between the second portion of the hot fluid and the plurality of tubes, to form a cooled fluid. An outlet downstream of the second flow nozzle, in communication with a final pass chamber, is adapted for receiving the cooled fluid.

### FIELD

The present embodiments relate to a heat exchanger for a compressor.

### BACKGROUND

A need exists for a highly versatile and adaptive heat exchanger having a plurality of pass chambers and tubes for optimizing heat transfer and pressure drop between a hot fluid and a cooling media, further being adaptable to having different numbers of tubes and different diameters of tubes in each pass chamber.

A further need exists for a heat exchanger having pass chambers fluidly engaged in sequence, with fluid being introduced into both a first pass chamber and one or more downstream pass chambers, forming a reduced rate of fluid flow in preceding pass chambers while maximizing heat transfer and pressure drop between the hot fluid and the cooling media in downstream pass chambers.

The present embodiments meet these needs.

### BRIEF DESCRIPTION OF THE DRAWINGS

The detailed description will be better understood in conjunction with the accompanying drawings as follows:

FIG. 1 depicts a diagram of an embodiment of the heat exchanger.

FIG. 2 depicts a diagram of an alternate embodiment of the heat exchanger.

FIG. 3 depicts a cross section of an embodiment of a pass chamber of the heat exchanger.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The present embodiments relate to a heat exchanger for a compressor.

The present heat exchanger provides the unique benefit of providing optimized heat transfer and pressure drop between hot fluid that is kept flowing as a fluid flow, and a cooling media through the use of multiple pass chambers having a plurality of tubes for contacting the cooling media with the hot fluid.

In an embodiment, the heat exchanger can be used to flow hot fluid into both upstream and downstream pass chambers and form a substantially reduced rate of fluid flow in preceding chambers, while optimizing heat transfer and pressure drop between the downstream portion of the hot fluid.

In this embodiment, two nozzles can be used with the heat exchanger, to flow hot fluid into each pass chamber respectively. Hot fluid can flow from the first pass chamber sequentially into the second pass chamber while fluid from both nozzles is flowed into the chambers.

The cooled fluid can then be mixed using a valve with additional hot liquid, in an embodiment, or in a different embodiment, the cooled fluid can be directly emitted from the final pass chamber.

The heat exchanger provides the benefit of being able to shut off a portion, such as up 83 percent, of the pass chambers and still accomplish adequate cooling of the hot fluid. This is a more cost effective solution than current alternatives, but being up to 50 percent cheaper to run than comparable units providing cooling fluid to devices, such as compressors.

This heat exchanger is contemplated to be more cost effective than comparable heat exchangers. The embodiments of the current heat exchanger has fewer parts which save on maintenance costs because the heat exchanger of the present invention can replace another cooling system that requires a pump.

This heat exchanger is less expensive to make, does not require hazardous cooling fluid, and does not require additional heat exchangers to cool the hot fluid.

In an embodiment, the heat exchanger includes a housing for holding the cooling media around the tubes.

The housing of the heat exchanger or of the cooling media can be made from any material capable of permitting heat transfer between the hot fluid and the cooling media, such as aluminum, stainless steel, carbon steel, admiralty brass, copper, alloys thereof and combinations thereof.

The housing can have a size that ranges from about 1 foot to about 30 feet in length, from about 0.5 feet to about 10 feet in height, and from about 4 inches to about 24 inches in thickness. Larger and smaller housings are contemplated depending on the size and flow of the hot fluid from the compressor. An exemplary housing, hereafter termed Heat Exchanger A, would be 4 feet tall, 12 feet long, and 1 foot thick.

The cooling media housing has an inlet port for the cooling media to flow into the cooling media housing.

In a contemplated embodiment, the housing can include a box header, for supporting a plurality of tubes in a pass chamber. Two box headers one on each end of the heat exchanger can be used. Each box header can be divided using pass plates to form multiple chambers.

The box header has a plurality of pass chambers for receiving hot fluid. Each pass chamber can range in size from about 50 gallons to about 100 gallons in volume.

Each pass chamber can have the same volume in an embodiment.

In another embodiment one or more pass chambers can have different volumes.

For example, in a housing that is six feet in length, a first pass chamber could have a volume of 10 gallons, and a second pass chamber could have a volume of 20 gallons.

From about 2 pass chambers to about 6 pass chambers can be used for each housing. More may be usable with larger housings.

As an example, the housing, can be six feet long, and can have 4 pass chambers. Each pass chamber can have a diameter of about 12 inches with 20 tubes in each pass chamber. Each tube can have a diameter of about ¾ of an inch.

In another example, the housing can be 12 feet long with 12 pass chambers, with 6 tubes in each chamber.

The tubes can be engaged within the housing in a force fit or welded together in the housing.

The tubes can have lengths ranging from about 1 foot to about 30 feet. The tubes can have varying diameters. For example, all tubes can have a diameter that ranges from about ½ of an inch to about 1 inch. Larger and smaller tube diameters may be usable, for example, tubes may be as small as ¼ of an inch and as large as 2 inches.

The tubes are preferably made from steel. The tubes can be made form other materials such as admiralty brass, aluminum, stainless steel, carbon steel, alloys there of combinations thereof.

Each tube in a pass chamber can have the same dimensions, or one or more tubes can have different dimensions within the same pass chamber. For example, one or more tubes can have different diameters.

It is contemplated that one pass chamber can have tubes of a first diameter, such as 100 tubes, each ¼ inch in diameter, while another pass chamber has a different number of differently sized tubes, such as 10 tubes, each 1 inch in diameter.

In an embodiment, each pass chamber can include from about 10 tubes to about 100 hundred tubes.

The cooling media surrounds the tubes. The cooling media is used for cooling the hot fluid as it contacts the tubes.

In an embodiment, the cooling media can include air or a similar non-volatile gas. For very hot liquids, the cooling media could be a liquid-vapor cooling media or vapor.

It is also contemplated that the cooling media can be a liquid such as oil, such as hydraulic oil, a glycol, such as ethylene glycol, or even water, or combinations thereof.

The housing is contemplated to be made form a substantially rigid material, with a wall thickness capable of resisting deformation.

One or more first flow nozzles, such as a 2 inch ANSI 150 flange, made by Boney Forge, having an address in Houston Tex. are used to introduce a first portion of the hot fluid into one or more first pass chambers. An embodiment contemplates that one housing can have a plurality of first pass chambers in tandem with a plurality of second pass chambers.

One or more second flow nozzles, downstream of the first flow nozzles, engage one or more downstream pass chambers, the plurality of first pass chambers are contemplated to be fluidly engaged in sequence, to second pass chambers, that is, a first pass chamber communicates with a second pass chamber. The nozzles are contemplated to have a pressure rating from about 100 psi to about 1300 psi.

In an embodiment, three first pass chambers can communicate in sequence with three second pass chambers which enable at least 3 areas with a substantially reduced rate of flow to be formed, enabling optimized heat transfer and pressure drop for cooling of the hot fluid prior to reaching a compressor. It is contemplated that the pressure drop of the hot fluid could drop from about 50 psi to about 5 psi in this invention.

From about 2 flow nozzles to about 6 flow nozzles can be used in an embodiment of the present heat exchanger.

Each flow nozzle can permit a flow rate for the hot fluid ranging from about 1 gallon per minute to about 300 gallons per minute.

For example, for a two foot long heat exchanger with a first pass chamber connected to a second pass chamber connected to a third pass chamber with 2 tubes in each pass chamber, and each tube being 2 inches in diameter, and oil as the cooling medium, the hot fluid can flow at a rate of 30 gallons per minute. For a 4×12×1 heat exchanger with 80 tubes total in all pass chambers the flow rate of the hot fluid can be 80 gallons per minute.

It is contemplated that in an embodiment, the present heat exchanger can include one or more valves disposed between the one or more first flow nozzles and the one or more second flow nozzles for mechanically controlling hot fluid flow between the nozzles. These valves are particularly useful to control the hot fluid flow rate if outside ambient air temperature drops or varies dramatically, such as in the deserts of Saudi, and the ambient temperatures affect the cooling media.

The valves can be a ball valve, such as KF valve, a butterfly valve, such as Apollo valve, a globe valve, such as Fisher valve, a gate valve, such as Apollo gate valve, other similar valves, or combinations thereof.

It is contemplated that an automatic valve, such as pneumatically actuated ball valve, made by Fisher having an address at Houston, Tex. can be disposed between the nozzles for electronically, pneumatically, or hydraulically and automatically controlling fluid flow between the first and second flow nozzles based on variable preset temperatures defined by a user.

The present heat exchanger includes an outlet downstream of the one or more second flow nozzles, in communication with a final pass chamber adapted for receiving the cooled fluid. This outlet can be controlled by a processor. The processor can control the opening of the outlet to keep the fluid flow rate through the outlet at preset rates defined by a user.

The outlet can be a nozzle or another type of outlet. The outlet can engage another heat exchanger.

In a contemplated embodiment, the hot fluid cooled by the present heat exchanger can have a temperature ranging from about 100 degrees Fahrenheit to about 300 degrees Fahrenheit.

The hot fluid can include a hydraulic fluid, heat exchange oil, lubricating oil, such as rotary screw compressor oil, a liquid oil/vapor mixture, or a vapor, or combinations thereof.

It is contemplated that the heat exchanger can be in communication with a temperature regulator, such as a thermostat made by AMOT, which can mix the cooled fluid from the outlet with hot fluid to form a warm fluid.

The present embodiments also relate to a method for providing heat exchange to a compressor

The method includes exposing a hot fluid to a cooling media.

A first portion of the hot fluid is introduced into a first pass chamber that includes a plurality of tubes.

A second portion of the hot fluid is flowed downstream of the first pass chamber, into one or more second pass chambers having a plurality of tubes while forming a reduced rate of fluid flow in at least the first pass chamber.

The hot fluid is cooled by maximizing contact between the second portion of the hot fluid and the plurality of tubes in the one or more second pass chambers, which optimizes the cooling of the fluid.

The cooled fluid is then flowed out of a final pass chamber downstream of the plurality of tubes in one or more second pass chambers.

In an embodiment, the cooled fluid can be mixed with hot fluid to form a warm fluid for use with a compressor.

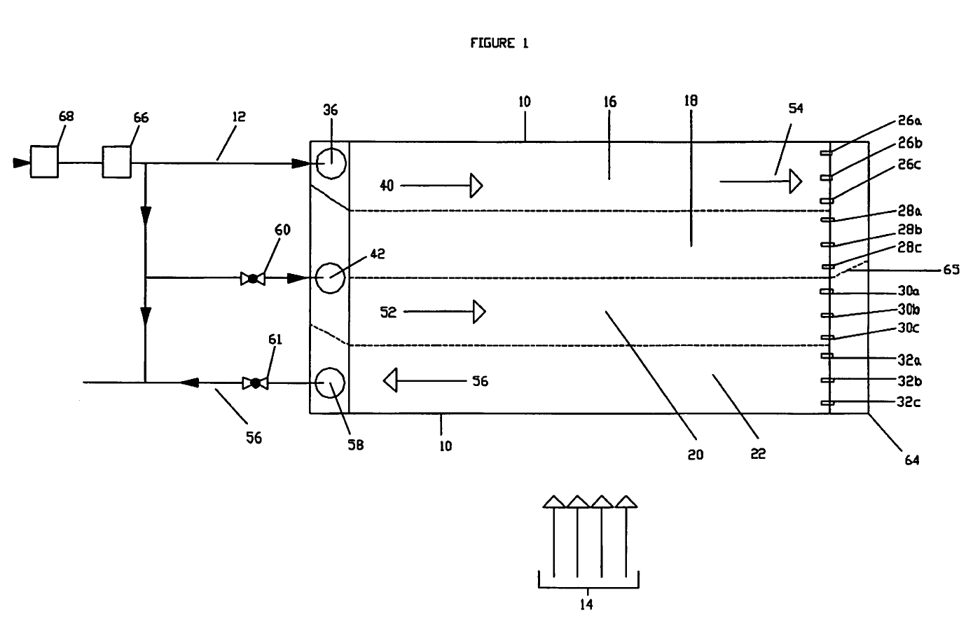

Referring now to FIG. 1, a diagram of an embodiment of the present heat exchanger is depicted.

The depicted heat exchanger has a housing (10), which encloses four pass chambers (16, 18, 20, and 22) each fluidly engaged in sequence. A boxed header (64) is depicted on one side of the heat exchanger, connected to tubes. A cooling media (14), such as cooling air having a temperature of 80 degrees Fahrenheit, surrounds the housing (10).

A first flow nozzle (36) introduces a first portion (40) of hot fluid (12), such as lubricating oil, having a temperature of 220 degrees Fahrenheit, from a hydraulic sump pump (66), such as a gear type pump made by Tuthill. The hydraulic sump pump (66) pumps fluid from a reservoir (68), such as a pressure vessel, having a capacity ranging from about 1 gallon to about 2000 gallons.

In an embodiment of the invention there can be more that one first flow nozzle. The first flow nozzles can be arranged in series or parallel allowing the first portion (40) of hot fluid (12) to be introduced into the first pass chamber (16).

The first portion (40) of hot fluid (12) can flow through a first pass chamber (16), where the first portion (40) contacts a first plurality of tubes (26a, 26b, and 26c). The cooling media (14) is contemplated to flow through the plurality of tubes (26a, 26b, and 26c), such that the contact between the hot fluid (12) and the tubes cools the hot fluid.

The first portion (40) can further flow through the boxed header (64) to a second pass chamber (18), where the first portion (40) contacts a second plurality of tubes (28a, 28b, and 28c) to be further cooled by the cooling media (14). The boxed header (64) contains a pass plate (65), which prevents the first portion (40) of hot fluid (12) from flowing into the third or fourth pass chambers (20 and 22).

A second flow nozzle (42) introduces a second portion (52) of the hot fluid (12) from the hydraulic sump pump (66) through a first valve (60), to the second pass chamber (18) and the third pass chamber (20). The first valve (60) can be any type of valve, including an automatic valve that controls the flow of hot fluid (12) using preset temperatures input by a user. There can be more than 1 second flow nozzle arranged in parallel or a series.

The introduction of the second portion (52) of hot fluid (12) creates a reduced rate of fluid flow (54) of the first portion (40) of hot fluid (12) in the first pass chamber (16), while maximizing contact of the second portion (52) of hot fluid (12) with the second plurality of tubes (28a, 28b, and 28c).

The second portion (52) further flows through the third pass chamber (20) to contact a third plurality of tubes (30a, 30b, and 30c), and through a fourth pass chamber (22) to contact a fourth plurality of tubes (32a, 32b, and 32c). The contact between the second portion (52) and the third and fourth pluralities of tubes (30a, 30b, and 30c and 32a, 32b, and 32c) is also maximized by the introduction of the second portion (52) through the second flow nozzle (42).

The second flow nozzle (42) can also allow hot fluid (12) to flow from the second pass chamber (18) into the third pass chamber (20).

As the hot fluid (12) contacts each plurality of tubes, the cooling media (14) cools the hot fluid, forming a cooled fluid (56), which can have any temperature cooler than that of the hot fluid (12), such as 170 degrees Fahrenheit, when the hot fluid (12) has a temperature of 220 degrees Fahrenheit.

The depicted heat exchanger includes an outlet (58), which can be a nozzle, for allowing the cooled fluid (56) to exit the housing (10), through a second valve (61), which can be any type of valve, including a temperature control valve.

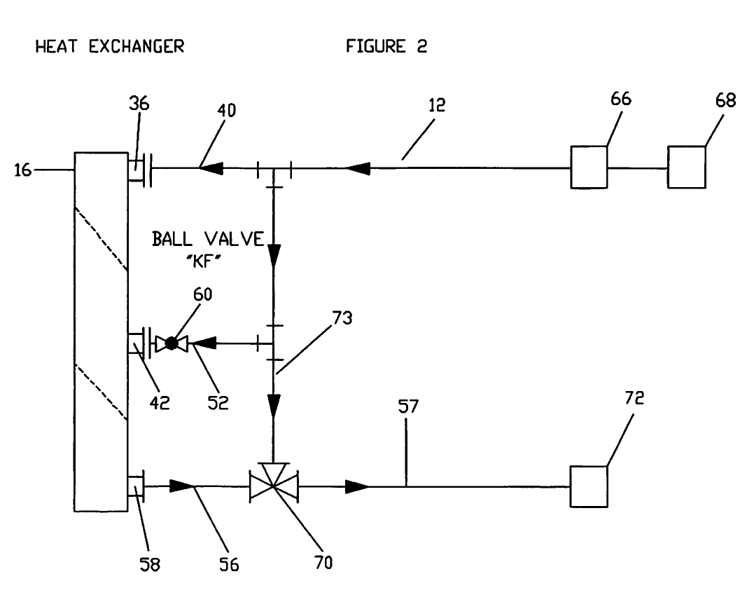

Referring now to FIG. 2, a diagram of an alternate embodiment of the present heat exchanger is depicted.

The present heat exchanger is shown. A hydraulic sump pump (66) flows hot fluid (12) from a reservoir (68).

A first portion (40) of the hot fluid (12) is flowed into the heat exchanger through a first flow nozzle (36), which is contemplated to be in communication with a first pass chamber of the heat exchanger.

A second portion (52) of the hot fluid (12) is flowed into the heat exchanger through a second flow nozzle (42), via a valve (60). The second flow nozzle (42) is contemplated to be in communication with one or more downstream pass chambers of the heat exchanger. The introduction of the second portion (52) into the downstream pass chambers creates a reduced rate of fluid flow (54) in the first portion (40) of the hot fluid (12) while optimizing the cooling of the second portion (52).

Cooled fluid (56) exits the heat exchanger through an outlet (58) and flows to a regulator (70), which can be a temperature regulator.

The hydraulic sump pump (66) flows a third portion (73) of the hot fluid (12) to the regulator (70), where the hot fluid (12) mixes with the cooled fluid (56) from the outlet (58) of the heat exchanger, forming a warm fluid (57).

FIG. 2 depicts the warm fluid (57) being flowed from the regulator (70) through a filter (72), such as a fiberglass media made by Donaldson.

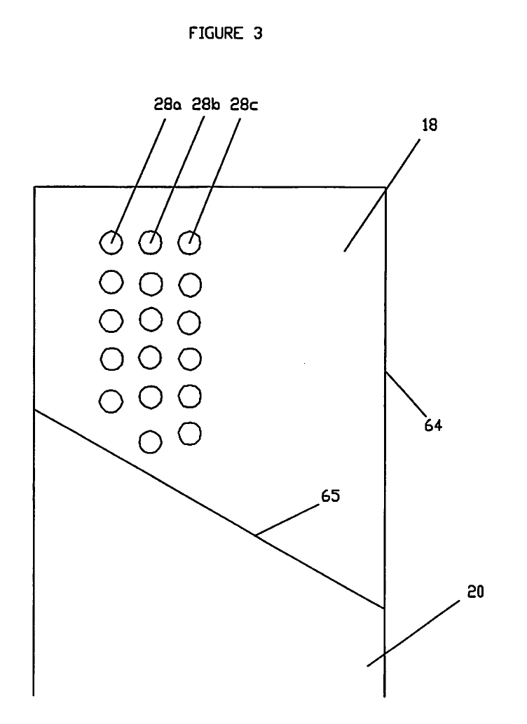

Referring now to FIG. 3, a cross section of an embodiment of a pass chamber is depicted.

The pass chamber (18) is shown having a plurality of tubes (28a, 28b, and 28c). Each tube can be engaged with the housing of the heat exchanger in a force fit, or welded to the housing.

It is contemplated that cooling media flows through each tube (28a, 28b, and 28c), enabling hot fluid within the pass chamber (18) to be cooled by contacting the tubes.

While FIG. 3 depicts a pass chamber (18) having 3 rows of identical tubes, it is contemplated that a pass chamber can have any number of tubes with any arrangement. It is further contemplated that each tube with a pass chamber can have identical or differing dimensions.

The pass chamber (18) is surrounded by the boxed header (64). A pass plate (65) separates the second pass chamber (18) from the third pass chamber (20).

While these embodiments have been described with emphasis on the embodiments, it should be understood that within the scope of the appended claims, the embodiments might be practiced other than as specifically described herein.

What is claimed is:

1. A heat exchanger for a compressor comprising:
a housing for exposing a hot fluid to a cooling media, wherein the housing comprises a plurality of pass chambers, and wherein each pass chamber comprises a plurality of tubes for contact with the cooling media;
at least one first flow nozzle for introducing a first portion of the hot fluid into at least one first pass chamber;
at least one second flow nozzle downstream of at least one first flow nozzle, wherein each second flow nozzle engages at least one downstream pass chamber and each downstream pass chamber is fluidly engaged in sequence, enabling a second portion of the hot fluid to flow into the at least one downstream pass chamber, substantially reducing a rate of fluid flow in the first pass chamber and optimizing heat transfer and pressure drop between the second portion of the hot fluid and the plurality of tubes to form a cooled fluid; and
an outlet downstream of the at least one second flow nozzle, in communication with a final pass chamber adapted for receiving the cooled fluid.

2. The heat exchanger of claim 1, further comprising a valve disposed between at least one first flow nozzle and at least one second flow nozzle for mechanically controlling hot fluid flow between the between the first flow nozzle and the second flow nozzle, wherein the valve is adapted to adjust fluid flow to bypass the at least first pass chamber.

3. The heat exchanger of claim 2, wherein the valve is a ball valve, a butterfly valve, a globe valve, a gate valve, or combinations thereof.

4. The heat exchanger of claim 1, further comprising an automatic valve disposed between the first flow nozzle and the second flow nozzle for electronically, pneumatically hydraulically automatically controlling fluid flow between the first flow nozzle and the second flow nozzle based on at least one preset temperature.

5. The heat exchanger of claim 1, wherein the housing further comprises a box header for supporting the plurality of tubes in the pass chamber.

6. The heat exchanger of claim 1, wherein the housing comprises from about 2 pass chambers to about 6 pass chambers.

7. The heat exchanger of claim 1, wherein each pass chamber comprises from about 10 tubes to about 100 tubes.

8. The heat exchanger of claim 7, wherein at least one pass chamber has a different number of tubes from another pass chamber.

9. The heat exchanger of claim 7, wherein at least one pass chamber has tubes with diameters different from the diameters of tubes of another pass chamber.

10. The heat exchanger of claim 1, wherein the first flow nozzle and the second flow nozzle have a pressure rating ranging from about 100 psi to about 1300 psi.

11. The heat exchanger of claim 1, wherein the first flow nozzle and the second flow nozzle permit a flow rate for the hot fluid ranging from about 1 gallon per minute to about 300 gallons per minute.

12. The heat exchanger of claim 1, wherein the hot fluid has a temperature ranging from about 100 degrees Fahrenheit to about 300 degrees Fahrenheit.

13. The heat exchanger of claim 1, wherein the hot fluid is a hydraulic fluid, a heat exchange oil, a lubricating oil, a liquid oil/vapor mixture, a vapor or combinations thereof.

14. The heat exchanger of claim 1, wherein the cooling media is air, an oil contained in a cooling fluid housing surrounding the housing, a glycol contained in a cooling fluid housing surrounding the housing, water contained in a cooling fluid housing surrounding the housing, or combinations thereof.

15. The heat exchanger of claim 1, wherein the housing has a size ranging from about 1 foot to about 30 feet in length, from about 0.50 feet to about 10 feet in height, and from about 4 inches to about 24 inches in thickness.

16. The heat exchanger of claim 1, wherein the housing and each of the plurality of tubes comprise a member of the group consisting of: aluminum, stainless steel, carbon steel, admiralty brass, alloys thereof or combinations thereof.

17. The heat exchanger of claim 1, wherein the outlet communicates with a second heat exchanger connected in series with the first heat exchanger.

18. The heat exchanger of claim 1, wherein the outlet is in communication with a temperature regulator for mixing the cooled fluid with hot fluid to form a warm fluid.

19. A method for providing cooled fluid to a compressor comprising:
exposing a hot fluid to a cooling media;
introducing a first portion of the hot fluid into a first pass chamber, wherein the first pass chamber comprises a first plurality of tubes in contact with the cooling media;
flowing a second portion of the hot fluid into at least one second pass chamber downstream of the first pass chamber, wherein the second pass chamber comprises a second plurality of tubes, substantially reducing a rate of fluid flow in the first pass chamber;
forming cooled fluid by optimizing contact between the second portion of hot fluid and the cooling media; and
exiting the cooled fluid to a final pass chamber downstream of the second plurality of tubes.

20. The method of claim 19, wherein the step of flowing the second portion of the hot fluid into the second pass chamber is performed using a manual valve, an automatic valve, or combinations thereof.

21. The method of claim 19, wherein the step of introducing the first portion of the hot fluid into the first pass chamber, the step of flowing the second portion of the hot fluid into the at least one second pass chamber, or combinations thereof, is performed at a flow rate ranging from about 1 gallon per minute to about 300 gallons per minute.

22. The method of claim 19, further comprising mixing the cooled fluid with hot fluid to form a warm fluid.
